(19) United States
(12) Patent Application Publication
(10) Pub. No.: US 2026/0214673 A1
(43) Pub. Date: Jul. 23, 2026

(54) CHANNEL DETECTION METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Ting FU, Beijing (CN)

(21) Appl. No.: 19/136,569

(22) PCT Filed: Dec. 7, 2022
(86) PCT No.: PCT/CN2022/137356

§ 371 Date: Jun. 6, 2025

(51) Int. Cl. H04W 72/21; H04W 72/0446

(52) U.S. Cl. CPC H04W 72/21; H04W 72/0446

(57) ABSTRACT

A channel detection method is performed by an access network device and includes: configuring a first configured grant (CG) physical uplink shared channel (PUSCH) configuration and a second CG PUSCH configuration, wherein the first CG PUSCH configuration includes a first CG PUSCH, and the second CG PUSCH configuration includes a second CG PUSCH; detecting the first CG PUSCH; and detecting uplink data on the second CG PUSCH when uplink data is detected on the first CG PUSCH.

### CROSS-REFERENCE TO RELATED APPLICATION

The present application is a U.S. National Stage of International Application No. PCT/CN 2022/137356, filed on Dec. 7, 2022, the content of which is incorporated herein by reference in its entirety.

### TECHNICAL FIELD

The present disclosure relates to, but is not limited to, the field of wireless communication technologies, and in particular to channel detection methods and apparatuses, communication devices and storage media.

### BACKGROUND

In 5th Generation Mobile Communication Technology (5G), a terminal can be configured with multiple sets of Configured Grant Physical Uplink Shared Channel (CG PUSCH) configurations, and the multiple sets of CG PUSCH configurations can be configured on the same or different transmission resources (e.g., carriers). On multiple sets of CG PUSCH uplink transmission resources, the terminal does not necessarily transmit uplink information on each resource, so a base station needs to perform detection. In related technologies, frequent detection will generate a lot of power consumption, which is not conducive to energy saving of the base station.

### SUMMARY

According to a first aspect of an embodiment of the present disclosure, a channel detection method is provided, which is performed by an access network device, and the method includes:
configuring at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH;
detecting the first CG PUSCH; and
detecting uplink data on the second CG PUSCH when uplink data is detected on the first CG PUSCH.

In an embodiment, the detecting uplink data on the second CG PUSCH includes:
detecting the uplink data on the second CG PUSCH after a first duration from a first time-domain position,
where the first time-domain position is determined based on a CG PUSCH resource for transmitting the uplink data.

In an embodiment, the first time-domain position is an end position of the detected CG PUSCH resource for transmitting the uplink data.

In an embodiment, a CG PUSCH configured for the terminal includes a low-priority CG PUSCH and/or a high-priority CG PUSCH.

In an embodiment, the high-priority CG PUSCH is configured as the first CG PUSCH.

In an embodiment, the detecting uplink data on the second CG PUSCH when uplink data is detected on the first CG PUSCH includes:
detecting at least one second CG PUSCH when first indication information is detected on the first CG PUSCH, where the first indication information indicates the at least one second CG PUSCH.

In an embodiment, the detecting at least one second CG PUSCH includes:
detecting the at least one second CG PUSCH after a second duration from a second time-domain position,
where the second time-domain position is determined based on a CG PUSCH resource for transmitting the indication information.

In an embodiment, the second time-domain position is an end position of the CG PUSCH resource where the indication information is detected on the first CG PUSCH.

In an embodiment, the first indication information is CG uplink control information (UCI) carried in a CG PUSCH.

In an embodiment, the CG UCI indicates index information of the at least one second CG PUSCH.

In an embodiment, the first duration is specified by a predetermined communication protocol or configured by the base station, and/or the second duration is specified by a predetermined communication protocol or configured by the base station.

According to a second aspect of an embodiment of the present disclosure, a channel detection apparatus is provided, including:
a configuration module, configured to configure at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH; and
a detection module, configured to detect the first CG PUSCH, and detect uplink data on the second CG PUSCH when uplink data is detected on the first CG PUSCH.

In an embodiment, the detection module is further configured to:
detect the uplink data on the second CG PUSCH after a first duration from a first time-domain position,
where the first time-domain position is determined based on a CG PUSCH resource for transmitting the uplink data.

In an embodiment, the detection module is further configured that the first time-domain position is an end position of the detected CG PUSCH resource for transmitting the uplink data.

In an embodiment, the configuration module is further configured that a CG PUSCH configured for the terminal includes a low-priority CG PUSCH and/or a high-priority CG PUSCH.

In an embodiment, the configuration module is further configured that the high-priority CG PUSCH determine as the first CG PUSCH.

In an embodiment, the detection module is further configured to:
detect at least one second CG PUSCH when first indication information is detected on the first CG PUSCH, where the first indication information indicates the at least one second CG PUSCH.

In an embodiment, the detection module is further configured to:
detect the at least one second CG PUSCH after a second duration from a second time-domain position,
where the second time-domain position is determined based on a CG PUSCH resource for transmitting the indication information.

In an embodiment, the detection module is further configured that the second time-domain position is an end position of the CG PUSCH resource where the indication information is detected to be transmitted on the first CG PUSCH.

In an embodiment, the detection module is further configured that the first indication information is CG uplink control information (UCI) carried in a CG PUSCH.

In an embodiment, the detection module is further configured that the CG UCI indicates index information of the at least one second CG PUSCH.

In an embodiment, the detection module is further configured that the first duration is specified by a predetermined communication protocol or configured by the base station, and/or the second duration is specified by a predetermined communication protocol or configured by the base station.

According to a third aspect of an embodiment of the present disclosure, a communication device is provided, including:
a processor; and
a memory, configured to store processor-executable instructions;
where the processor is configured to implement the method according to any embodiment of the present disclosure when the executable instructions are executed.

According to a fourth aspect of an embodiment of the present disclosure, a computer storage medium is provided, where the computer storage medium stores a computer executable program, and the executable program, when executed by a processor, realizes the method described in any embodiment of the present disclosure.

In the embodiments of the present disclosure, at least two sets of configured grant (CG) physical uplink shared channel (PUSCH) configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH is detected, and when uplink data is detected on the first CG PUSCH, uplink data on the second CG PUSCH is detected. Since the access network device will configure at least two sets of CG PUSCH configurations for the terminal, where the CG PUSCH configurations include a first CG PUSCH configuration and a second CG PUSCH configuration, and the first CG PUSCH will be detected first, and the uplink data of the second CG PUSCH will be detected only when the uplink data is detected on the first CG PUSCH. Compared with the method that requires detecting the first CG PUSCH and the second CG PUSCH at the same time, the number of CG PUSCH detections can be reduced, which is beneficial for access network device to save power consumption.

### BRIEF DESCRIPTION OF DRAWINGS

FIG. 1 is a schematic structural diagram of a wireless communication system according to an embodiment of the present disclosure.

FIG. 2 is a flowchart of a channel detection method according to an embodiment of the present disclosure.

FIG. 3 is a flowchart of a channel detection method according to an embodiment of the present disclosure.

FIG. 4 is a flowchart of a channel detection method according to an embodiment of the present disclosure.

FIG. 5 is a flowchart of a channel detection method according to an embodiment of the present disclosure.

FIG. 6 is a flowchart of a channel detection method according to an embodiment of the present disclosure.

FIG. 7 is a schematic diagram of a channel detection apparatus according to an embodiment of the present disclosure.

FIG. 8 is a schematic structural diagram of a terminal according to an embodiment of the present disclosure.

FIG. 9 is a block diagram of a base station according to an embodiment of the present disclosure.

FIG. 10 is a schematic diagram of a network architecture according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the embodiments of the present disclosure. Rather, they are merely examples of apparatuses and methods consistent with some aspects of embodiments of the present disclosure as detailed in the appended claims.

Terms used in embodiments of the present disclosure are only for a purpose of describing specific embodiments, and are not limiting the embodiments of the present disclosure. Singular forms of “a”, said“, and “the” used in the embodiments of the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the embodiments of the present disclosure, these information should not be limited to these terms. These terms are used only to distinguish the same type of information from one another. For example, without departing from the scope of the present disclosure, first information can also be named as second information, and similarly, the second information can also be named as the first information. Depending on the context, the word “if” as used herein can be interpreted as “at” or “when” or “in response to determining”.

For the purpose of simplicity and ease of understanding, the terms used in the present disclosure to represent size relationships are “greater than” or “less than”. But for those skilled in the art, it can be understood that the term “greater than” also covers the meaning of “greater than or equal to” and “less than” also covers the meaning of “less than or equal to”.

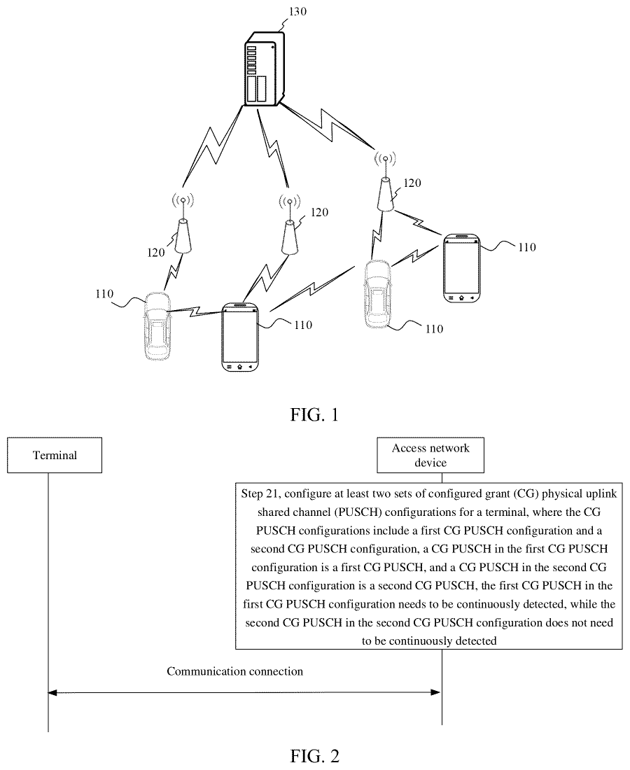

Please refer to FIG. 1, which shows a schematic structural diagram of a wireless communication system according to an embodiment of the present disclosure. As shown in FIG. 1, the wireless communication system is a communication system based on mobile communication technology, and the wireless communication system may include: at least one user equipment 110 and at least one access network node. For example, the access network node may be a base station 120. The user equipment 110 may be a terminal. The terminals covered by the present disclosure may be, but are not limited to, a cell phone, a wearable device, an in-vehicle terminal, a road side unit (RSU), a smart home terminal, an industrial sensing device, and/or a medical device, etc. In some examples, the terminal may be a Redcap terminal or a new radio (NR) terminal of a predetermined version (e.g., an NR terminal of R17).

A user equipment 110 may be a device that provides voice and/or data connectivity to users. The user equipment 110 can communicate with one or more core networks via a radio access network (RAN). The user equipment 110 can be an Internet of Things user equipment, such as a sensor device, a mobile phone and a computer with an Internet of Things user equipment. For example, it can be a fixed, portable, pocket-sized, handheld, computer-built or vehicle-mounted device. For example, a station (STA), a subscriber unit, a subscriber station, a mobile station, a mobile, a remote station, an access point, a remote terminal, an access terminal, a user terminal, a user agent, a user device, or a user equipment. Or, the user equipment 110 can also be a device for an unmanned aerial vehicle. Or, the user equipment 110 can also be a vehicle-mounted device, for example, a driving computer with wireless communication function or a wireless user equipment with an external driving computer. Or, the user equipment 110 can also be a roadside device, such as a street lamp, a signal lamp or other roadside device with wireless communication function.

The base station 120 may be a network-side device in a wireless communication system. The wireless communication system can be the 4th generation mobile communication (4G) system, also known as long term evolution (LTE) system. Or, the wireless communication system can also be a 5G system, also known as a new radio (NR) system or a 5G NR system. Or, the wireless communication system may be a next generation system of the 5G system or other future wireless communication systems. An access network in the 5G system can be named as a new generation-radio access network (NG-RAN).

The base station 120 may be an evolved Node B (eNB) adopted in the 4G system. Or, the base station 120 can also be a next generation Node B (gNB) adopting a centralized and distributed architecture in the 5G system. When the base station 120 adopts a centralized and distributed architecture, it usually includes a central unit (CU) and at least two distributed units (DUs). The centralized unit is provided with a protocol stack of a packet data convergence protocol (PDCP) layer, a radio link Control Protocol (RLC) layer and a media access control (MAC) layer, a distributed unit is provided with a protocol stack of a physical (PHY) layer, and the embodiments of the present disclosure do not limit specific implementations of the base station 120.

A wireless connection can be established between the base station 120 and the user equipment 110 through a wireless air interface. In different implementations, the wireless air interface is a wireless air interface based on the fourth generation mobile communication network technology (4G) standard; or the wireless radio is a wireless air interface based on the fifth generation mobile communication network technology (5G) standard, for example, the wireless air interface is a new radio; or, the wireless air interface can also be a wireless air interface based on the next generation mobile communication network technical standard of 5G or other future wireless communication technical standards.

In some examples, an end to end (E2E) connection can further be established between the user equipments 110. For example, scenarios of vehicle to vehicle (V2V) communication, vehicle to Infrastructure (V2I) communication and vehicle to pedestrian (V2P) communication in vehicle to everything (V2X) communication.

Here, the above-mentioned user equipment can be considered as a terminal device of the following embodiments.

In some examples, the above-mentioned wireless communication system may further include a core network device 130.

The base station 120 is connected to the core network device 130. The core network device 130 may be a core network device in the wireless communication system, where the core network device may correspond to network functions, such as communication nodes such as access and mobility management function (AMF), User Plane Function (UPF) and Session Management Function (SMF). Embodiments of the present disclosure do not limit the implementation form of the core network device 130.

In some embodiments of the present application, the core network device 130 includes a network function that provides a location function. For example, in a 5G network, a location management function (LMF) is a network element, module or component that provides the location function. For another example, in a 4G network, an evolved serving mobile location center (ESMLC) is a network element, module or component that provides the location function. It can be understood that in other networks, it can be other functional network elements.

It should be noted that, in some other embodiments, the access network node may also integrate a module or component with the location function. In this example, the access network node is a network element, module or component that provides the location function.

In order to facilitate the understanding of those skilled in the art, the embodiments of the present disclosure list a plurality of implementations to clearly explain the technical solution of the embodiments of the present disclosure. Of course, those skilled in the art can understand that the multiple embodiments provided in the present disclosure can be executed separately, combined with the methods of other embodiments in the present disclosure, or executed separately or in combination with some methods in other related technologies. Embodiment of that present disclosure do not limit this.

The application scenarios involved in the present disclosure are described below.

In an embodiment, a terminal can be configured with multiple sets of Configured Grant Physical Uplink Shared Channel (CG PUSCH) configurations, and the multiple sets of CG PUSCH configurations may be configured on the same or different transmission resources (e.g., carriers). On multiple sets of CG PUSCH uplink transmission resources, the terminal does not necessarily transmit uplink information on each resource, so a base station needs to perform blind detection.

In an embodiment, CG PUSCHs configured by the base station for the terminal includes Type 1 CG PUSCH and Type 2 CG PUSCH. Type 1 CG PUSCH allows the terminal to periodically transmit uplink data on the configured CG PUSCH resources after being configured by the base station through Radio Resource Control (RRC) signaling. When the base station deletes the CG PUSCH configuration through RRC reconfiguration process, the CG PUSCH resource configuration becomes invalid. Type 2 CG PUSCH can only be used after the base station is configured by RRC signaling and activated by Downlink Control Information (DCI). When the base station deactivates the CG PUSCH through DCI, the terminal can no longer use the CG-PUSCH resource.

In an embodiment, different sets of CG PUSCHs may be configured with different priorities. For example, a priority can be configured for a CG PUSCH through higher layer signaling (e.g., there are 2 priorities, high priority and low priority). CG PUSCHs with different priorities can be used to carry different types of services, e.g., services with different priorities. In an example, high-priority services are carried on a high-priority CG PUSCH and low-priority services are carried on a low-priority CG PUSCH. High-priority services are, for example, services that require low latency and high transmission accuracy, such as video conferencing services. Low-priority services include services with high latency and low transmission rates, such as meter reading services.

In an embodiment, the terminal may send configured grant uplink control information (CG UCI) along with the configured CG PUSCH. CG UCI is the uplink control information sent along with each CG PUSCH. In related technologies, CG UCI includes information such as Hybrid Automatic Repeat reQuest (HARQ) process identifiers, version numbers, new data indicators, and Channel Occupancy Time (COT) sharing.

It can be understood that the network architecture and application scenarios described in the embodiments of the present disclosure are intended to more clearly illustrate the technical solutions of the embodiments of the present disclosure and do not constitute a limitation of the technical solutions provided by the embodiments of the present disclosure, and a person of ordinary skill in the art may know that, with an evolution of a system architecture and an emergence of a new business scenario, the technical solutions provided by the embodiments of the present disclosure are equally applicable to similar technical problems.

As shown in FIG. 2, a channel detection method is provided in the embodiment, which is performed by an access network device, and the method includes the following step.

Step 21: configuring at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected.

The terminals covered by the present disclosure may be, but are not limited to, a cell phone, a wearable device, an in-vehicle terminal, a road side unit (RSU), a smart home terminal, an industrial sensing device, and/or a medical device, etc. In some examples, the terminal may be a Redcap terminal or a new radio (NR) terminal of a predetermined version (e.g., an NR terminal of R17).

The access network device involved in the present disclosure may be a base station, and the base station may be various types of base stations, for example, a base station for a third-generation mobile communication (3G) network, a base station for a fourth-generation mobile communication (4G) network, a base station for a fifth-generation mobile communication (5G) network, or other evolved base stations.

In an embodiment, the first CG PUSCH configuration and/or the second CG PUSCH configuration are determined from at least two sets of CG PUSCH configurations configured for the terminal. The CG PUSCH in the first CG PUSCH configuration is the first CG PUSCH, and the CG PUSCH in the second CG PUSCH configuration is the second CG PUSCH. The first CG PUSCH in the first CG PUSCH configuration needs to be continuously detected, while the second CG PUSCH in the second CG PUSCH configuration does not need to be continuously detected.

In some examples, the CG PUSCH configured in the first CG PUSCH configuration is the first CG PUSCH. It can be understood that the first CG PUSCH in the present disclosure corresponds to the first CG PUSCH configuration. The CG PUSCH configured in the second CG PUSCH configuration is the second CG PUSCH. It can be understood that the second CG PUSCH in the present disclosure corresponds to the second CG PUSCH configuration.

In some examples, continuously detecting the first CG PUSCH may mean always detecting the first CG PUSCH, for example, always detecting the first CG PUSCH according to a set period. It can be understood that continuously detecting the first CG PUSCH means that the first CG PUSCH needs to be detected in each slot of the first CG PUSCH. The second CG PUSCH does not need to be continuously detected, which means that when a predetermined detection condition is not met, there is no need to detect the second CG PUSCH. Or, the second CG PUSCH is detected only when the predetermined detection condition is met. It can be understood that continuously detecting the second CG PUSCH means that the second CG PUSCH needs to be detected in each slot of the second CG PUSCH.

In some examples, the detection of CG PUSCH may be blind detection of CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously blindly detected, while the second CG PUSCH in the second CG PUSCH configuration does not need to be continuously blindly detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. Uplink data of the first CG PUSCH is detected. In response to a predetermined detection condition being met, uplink data of the second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting uplink data on the first CG PUSCH, uplink data on the second CG PUSCH is detected; or, in response to not detecting uplink data on the first CG PUSCH, uplink data on the second CG PUSCH is not detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting uplink data on the first CG PUSCH, uplink data on the second CG PUSCH is detected after a first duration from a first time-domain position.

In an embodiment, the first time-domain position is determined based on a CG PUSCH resource for transmitting the uplink data. For example, the first time-domain position may be an end position of the CG PUSCH resource for transmitting the uplink data; or, the first time-domain position may be a start position of the CG PUSCH resource for transmitting the uplink data. In an embodiment, the first duration may be determined based on a transmission duration determined by the CG PUSCH resource for transmitting the uplink data and a demodulation duration of the uplink data, for example, the first duration is greater than or equal to a sum of the transmission duration determined by the CG PUSCH resource for transmitting the uplink data and the demodulation duration of the uplink data.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting uplink data on the first CG PUSCH, uplink data on the second CG PUSCH is detected after a first duration from a first time-domain position, where the first time-domain position is the end position of the CG PUSCH resource for transmitting the uplink data. In some examples, while detecting the uplink data of the second CG PUSCH, the uplink data of the first CG PUSCH is continuously detected.

In an embodiment, the first duration is specified by a predetermined communication protocol or configured by the base station. In some examples, the first duration may be used for the base station to complete a process of demodulating uplink data transmitted by the CG PUSCH. In other words, the first duration is greater than or equal to a duration required for the base station to complete demodulation of uplink data transmitted by the CG PUSCH.

In an embodiment, a CG PUSCH configured for the terminal includes a low-priority CG PUSCH and/or a high-priority CG PUSCH. In some examples, CG PUSCH with different priorities can be used to carry uplink services with different priorities. For example, high-priority services are carried on a high-priority CG PUSCH and low-priority services are carried on a low-priority CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH in the first CG PUSCH configuration may include a high-priority CG PUSCH and a low-priority CG PUSCH, and the second CG PUSCH in the second CG PUSCH configuration may include a high-priority CG PUSCH and a low-priority CG PUSCH. In some examples, a high-priority CG PUSCH in the CG PUSCH configuration will be detected first.

In an embodiment, the access network device may configure the CG PUSCH, for example, via Radio Resource Control (RRC) signaling. The CG PUSCH configuration may include priority information. For example, the configuration of CG PUSCH includes a first CG PUSCH configuration and a second CG PUSCH configuration. The first CG PUSCH configuration may include priority information of the first CG PUSCH configuration, which is also the priority information of the first CG PUSCH in the first CG PUSCH configuration. The second CG PUSCH configuration may include priority information of the second CG PUSCH configuration, which is also the priority information of the second CG PUSCH in the second CG PUSCH configuration. The priority information indicates the priority. It may be understood that when time-frequency resources corresponding to a high-priority CG PUSCH configuration overlap with time-frequency domain resources corresponding to a low-priority CG PUSCH configuration, the time-frequency resources of the high-priority CG PUSCH configuration are detected first, or when time-frequency resources corresponding to a high-priority CG PUSCH overlap with time-frequency resources corresponding to a low-priority CG PUSCH, the time-frequency resources of the high-priority CG PUSCH are detected first.

Based on this, it may be understood that the priority corresponding to the priority information may be set for the CG PUSCH configuration or for the CG PUSCH in the CG PUSCH configuration, which is not limited in the present disclosure.

In an embodiment, if the CG PUSCH is configured as a low priority, the CG PUSCH in the CG PUSCH configuration also corresponds to a low priority; or, if the CG PUSCH is configured as a high priority, the CG PUSCH in the CG PUSCH configuration also corresponds to a high priority.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH in the first CG PUSCH configuration is a high-priority CG PUSCH, and the second CG PUSCH in the second CG PUSCH configuration is a low-priority CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting first indication information indicating at least one second CG PUSCH on the first CG PUSCH, the at least one second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting first indication information indicating a configuration of at least one second CG PUSCH on a CG PUSCH in the first CG PUSCH configuration, the at least one second CG PUSCH is detected.

In some examples, the first indication information may be indication information for the configuration of the CG PUSCH, or may be indication information for the CG PUSCH in the configuration of the CG PUSCH, which is not limited in the present disclosure.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting first indication information indicating at least one second CG PUSCH on the first CG PUSCH, the at least one second CG PUSCH is detected after a second duration from a second time-domain position.

In an embodiment, the second time-domain position is determined based on a CG PUSCH resource for transmitting the first indication information. For example, the second time-domain position may be an end position of the CG PUSCH resource for transmitting the first indication information, or the second time-domain position may be a start position of the CG PUSCH resource for transmitting the first indication information. In an embodiment, the second duration may be determined by a sum of a transmission duration determined based on the CG PUSCH resource for transmitting the first indication information and a demodulation duration of the first indication information, for example, the second duration is greater than or equal to the transmission duration determined based on the CG PUSCH resource for transmitting the first indication information and the demodulation duration of the uplink data, for another example, the second duration is greater than or equal to the sum of the transmission duration determined based on the CG PUSCH resource for transmitting the first indication information and the demodulation duration of the first indication information.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting first indication information indicating at least one second CG PUSCH on the first CG PUSCH, the at least one second CG PUSCH is detected after a second duration from a second time-domain position, where the second time-domain position is an end position of the CG PUSCH resource for transmitting the first indication information on the first CG PUSCH.

In an embodiment, the second duration is specified by a predetermined communication protocol or configured by the base station. In some examples, the second duration is used for the base station to complete a process of demodulating the indication information. In other words, the second duration is greater than or equal to a duration required for the base station to complete demodulation of the indication information.

If the indication information is CG UCI, the second duration may be used for the base station to complete a process of demodulating the CG UCI. In some examples, the CG UCI is included in the CG PUSCH, but since a position of the CG UCI in the CG PUSCH is predefined by a predetermined communication protocol, the demodulation of the CG UCI is independent of the demodulation of the CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. The first CG PUSCH is detected. In response to detecting CG UCI indicating at least one second CG PUSCH on the first CG PUSCH, the at least one second CG PUSCH is detected after a second duration from a second time-domain position, where the second time-domain position is an end position of the CG PUSCH resource for transmitting the indication information on the first CG PUSCH. The indication information is the CG UCI carried in the CG PUSCH, and the CG UCI indicates index information of the at least one second CG PUSCH.

In some examples, CG UCI may also include a Hybrid Automatic Repeat request (HARQ) process identifier, a version number, a new data indicator, and a Channel Occupancy Time (COT) sharing.

In the embodiment of the present disclosure, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH, the first CG PUSCH in the first CG PUSCH configuration needs to be continuously detected, while the second CG PUSCH in the second CG PUSCH configuration does not need to be continuously detected. Since the access network device configures at least two sets of CG PUSCH configurations for the terminal, where the CG PUSCH configurations include a first CG PUSCH configuration and a second CG PUSCH configuration, and the first CG PUSCH in the first CG PUSCH configuration needs to be continuously detected, while the second CG PUSCH in the second CG PUSCH configuration does not need to be continuously detected, the access network device may only need to continuously detect the first CG PUSCH in the first CG PUSCH configuration without continuously detecting the second CG PUSCH in the second CG PUSCH configuration, thereby reducing the number of CG PUSCH detections and saving power for the access network device.

In some examples, those skilled in the art can understand that the methods provided by the embodiments of the present disclosure can be executed alone or together with some methods in the embodiments of the present disclosure or some methods in related technologies.

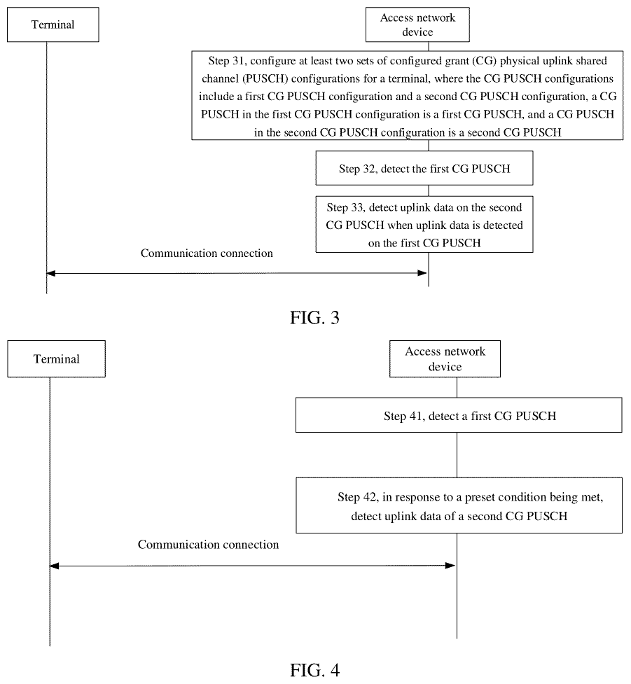

As shown in FIG. 3, a channel detection method is provided in the embodiment, which is performed by an access network device, and the method includes the following steps.

Step 31: configuring at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH.

Step 32: detecting the first CG PUSCH.

Step 33: detecting uplink data on the second CG PUSCH when uplink data is detected on the first CG PUSCH.

The terminals covered by the present disclosure may be, but are not limited to, a cell phone, a wearable device, an in-vehicle terminal, a road side unit (RSU), a smart home terminal, an industrial sensing device, and/or a medical device, etc. In some examples, the terminal may be a Redcap terminal or a new radio (NR) terminal of a predetermined version (e.g., an NR terminal of R17).

The access network device involved in the present disclosure may be a base station, and the base station may be various types of base stations, for example, a base station for a third-generation mobile communication (3G) network, a base station for a fourth-generation mobile communication (4G) network, a base station for a fifth-generation mobile communication (5G) network, or other evolved base stations.

In an embodiment, the first CG PUSCH configuration and the second CG PUSCH configuration are determined from at least two sets of CG PUSCH configurations configured for the terminal. The CG PUSCH in the first CG PUSCH configuration is the first CG PUSCH, and the CG PUSCH in the second CG PUSCH configuration is the second CG PUSCH. The first CG PUSCH is detected, and when uplink data is detected on the first CG PUSCH, uplink data on the second CG PUSCH is detected.

In some examples, the CG PUSCH configured in the first CG PUSCH configuration is the first CG PUSCH. It can be understood that the first CG PUSCH in the present disclosure corresponds to the first CG PUSCH configuration. The CG PUSCH configured in the second CG PUSCH configuration is the second CG PUSCH. It can be understood that the second CG PUSCH in the present disclosure corresponds to the second CG PUSCH configuration.

In some examples, continuously detecting the first CG PUSCH may mean always detecting the first CG PUSCH, for example, always detecting the first CG PUSCH according to a set period. It can be understood that continuously detecting the first CG PUSCH means that the first CG PUSCH needs to be detected in each slot of the first CG PUSCH. The second CG PUSCH does not need to be continuously detected, which means that when a predetermined detection condition is not met, there is no need to detect the second CG PUSCH. Or, the second CG PUSCH is detected only when the predetermined detection condition is met. It can be understood that continuously detecting the second CG PUSCH means that the second CG PUSCH needs to be detected in each slot of the second CG PUSCH.

In some examples, the detection of CG PUSCH may be blind detection of CG PUSCH.

In an embodiment, at least two sets of CG PUSCH configurations are configured for the terminal, where the CG PUSCH configurations include a first CG PUSCH configuration and a second CG PUSCH configuration. The CG PUSCH in the first CG PUSCH configuration is the first CG PUSCH, and the CG PUSCH in the second CG PUSCH configuration is the second CG PUSCH. Blind detection is performed on the first CG PUSCH, and when uplink data is blindly detected on the first CG PUSCH, blind detection is performed on uplink data of the second CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. Uplink data of the first CG PUSCH is detected. In response to a predetermined detection condition being met, uplink data of the second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected; or, in response to not detecting uplink data on the first CG PUSCH, uplink data on the second CG PUSCH is not detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected after a first duration from a first time-domain position.

In an embodiment, the first time-domain position is determined based on a CG PUSCH resource for transmitting the uplink data. For example, the first time-domain position may be an end position of the CG PUSCH resource for transmitting the uplink data; or, the first time-domain position may be a start position of the CG PUSCH resource for transmitting the uplink data. In an embodiment, the first duration may be determined based on a transmission duration determined by the CG PUSCH resource for transmitting the uplink data and a demodulation duration of the uplink data, for example, the first duration is greater than or equal to a sum of the transmission duration determined by the CG PUSCH resource for transmitting the uplink data and the demodulation duration of the uplink data.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected after a first duration from a first time-domain position, where the first time-domain position is the end position of the CG PUSCH resource for transmitting the uplink data. In some examples, while detecting the uplink data of the second CG PUSCH, the uplink data of the first CG PUSCH is continuously detected.

In an embodiment, the first duration is specified by a predetermined communication protocol or configured by the base station. In some examples, the first duration may be used for the base station to complete a process of demodulating uplink data transmitted by the CG PUSCH. In other words, the first duration is greater than or equal to a duration required for the base station to complete demodulation of uplink data transmitted by the CG PUSCH.

In an embodiment, a CG PUSCH configured for the terminal includes a low-priority CG PUSCH and/or a high-priority CG PUSCH. In some examples, CG PUSCH with different priorities can be used to carry uplink services with different priorities. For example, high-priority services are carried on a high-priority CG PUSCH and low-priority services are carried on a low-priority CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH in the first CG PUSCH configuration may include a high-priority CG PUSCH and a low-priority CG PUSCH, and the second CG PUSCH in the second CG PUSCH configuration may include a high-priority CG PUSCH and a low-priority CG PUSCH. In some examples, a high-priority CG PUSCH in the CG PUSCH configuration will be detected first.

In an embodiment, the access network device may configure the CG PUSCH, for example, via Radio Resource Control (RRC) signaling. The CG PUSCH configuration may include priority information. For example, the configuration of CG PUSCH includes a first CG PUSCH configuration and a second CG PUSCH configuration. The first CG PUSCH configuration may include priority information of the first CG PUSCH configuration, which is also the priority information of the first CG PUSCH in the first CG PUSCH configuration. The second CG PUSCH configuration may include priority information of the second CG PUSCH configuration, which is also the priority information of the second CG PUSCH in the second CG PUSCH configuration. The priority information indicates the priority. It may be understood that when time-frequency resources corresponding to a high-priority CG PUSCH configuration overlap with time-frequency domain resources corresponding to a low-priority CG PUSCH configuration, the time-frequency resources of the high-priority CG PUSCH configuration are detected first, or when time-frequency resources corresponding to a high-priority CG PUSCH overlap with time-frequency resources corresponding to a low-priority CG PUSCH, the time-frequency resources of the high-priority CG PUSCH are detected first.

Based on this, it may be understood that the priority corresponding to the priority information may be set for the CG PUSCH configuration or for the CG PUSCH in the CG PUSCH configuration, which is not limited in the present disclosure.

In an embodiment, if the CG PUSCH is configured as a low priority, the CG PUSCH in the CG PUSCH configuration also corresponds to a low priority; or, if the CG PUSCH is configured as a high priority, the CG PUSCH in the CG PUSCH configuration also corresponds to a high priority.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH in the first CG PUSCH configuration is a high-priority CG PUSCH, and the second CG PUSCH in the second CG PUSCH configuration is a low-priority CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating a configuration of at least one second CG PUSCH on a CG PUSCH in the first CG PUSCH configuration, the at least one second CG PUSCH is detected.

In some examples, the first indication information may be indication information for the configuration of the CG PUSCH, or may be indication information for the CG PUSCH in the configuration of the CG PUSCH, which is not limited in the present disclosure.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected after a second duration from a second time-domain position.

In an embodiment, the second time-domain position is determined based on a CG PUSCH resource for transmitting the first indication information. For example, the second time-domain position may be an end position of the CG PUSCH resource for transmitting the first indication information, or the second time-domain position may be a start position of the CG PUSCH resource for transmitting the first indication information. In an embodiment, the second duration may be determined by a transmission duration determined based on the CG PUSCH resource for transmitting the first indication information and a demodulation duration of the first indication information, for example, the second duration is greater than or equal to the sum of the transmission duration determined based on the CG PUSCH resource for transmitting the first indication information and the demodulation duration of the first indication information.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected after a second duration from a second time-domain position, where the second time-domain position is an end position of the CG PUSCH resource for transmitting the indication information on the first CG PUSCH.

In an embodiment, the second duration is specified by a predetermined communication protocol or configured by the base station. In some examples, the second duration is used for the base station to complete a process of demodulating the indication information. In other words, the second duration is greater than or equal to a duration required for the base station to complete demodulation of the indication information.

If the indication information is CG UCI, the second duration may be used for the base station to complete a process of demodulating the CG UCI. In some examples, the CG UCI is included in the CG PUSCH, but since a position of the CG UCI in the CG PUSCH is predefined by a predetermined communication protocol, the demodulation of the CG UCI is independent of the demodulation of the CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting CG UCI indicating at least one second CG PUSCH on the first CG PUSCH, the at least one second CG PUSCH is detected after a second duration from a second time-domain position, where the second time-domain position is an end position of the CG PUSCH resource for transmitting the CG UCI on the first CG PUSCH. The indication information is the CG UCI carried in the CG PUSCH, and the CG UCI indicates index information of the at least one second CG PUSCH.

In some examples, CG UCI may also include a Hybrid Automatic Repeat request (HARQ) process identifier, a version number, a new data indicator, and a Channel Occupancy Time (COT) sharing.

In the embodiment of the present disclosure, at least two sets of CG PUSCH configurations are configured for the terminal, where the CG PUSCH configurations include a first CG PUSCH configuration and a second CG PUSCH configuration. The CG PUSCH in the first CG PUSCH configuration is the first CG PUSCH, and the CG PUSCH in the second CG PUSCH configuration is the second CG PUSCH. The first CG PUSCH is detected, and when uplink data is detected on the first CG PUSCH, uplink data on the second CG PUSCH is detected. Since the access network device will configure at least two sets of CG PUSCH configurations for the terminal, where the CG PUSCH configurations include a first CG PUSCH configuration and a second CG PUSCH configuration. The CG PUSCH in the first CG PUSCH configuration is the first CG PUSCH, and the CG PUSCH in the second CG PUSCH configuration is the second CG PUSCH. The first CG PUSCH will be detected first, and the uplink data of the second CG PUSCH will be detected only when the uplink data is detected on the first CG PUSCH. Compared with the method that requires detecting the first CG PUSCH and the second CG PUSCH at the same time, the number of CG PUSCH detections can be reduced, which is beneficial for access network device to save power consumption.

In some examples, those skilled in the art can understand that the methods provided by the embodiments of the present disclosure can be executed alone or together with some methods in the embodiments of the present disclosure or some methods in related technologies.

As shown in FIG. 4, a channel detection method is provided in the embodiment, which is performed by an access network device or a network function, and the method includes the following steps.

Step 41: detecting a first CG PUSCH.

Step 42: in response to a preset condition being met, detecting uplink data of a second CG PUSCH.

In an embodiment, the first CG PUSCH in the first CG PUSCH configuration needs to be continuously detected, while the second CG PUSCH in the second CG PUSCH configuration does not need to be continuously detected.

In some examples, the preset condition may be a condition associated with a detection result of the first CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected after a first duration from a first time-domain position.

In an embodiment, the first time-domain position is determined based on a CG PUSCH resource for transmitting the uplink data. For example, the first time-domain position may be an end position of the CG PUSCH resource for transmitting the uplink data; or, the first time-domain position may be a start position of the CG PUSCH resource for transmitting the uplink data. In an embodiment, the first duration may be determined based on a transmission duration determined by the CG PUSCH resource for transmitting the uplink data and a demodulation duration of the uplink data, for example, the first duration is greater than or equal to a sum of the transmission duration determined by the CG PUSCH resource for transmitting the uplink data and the demodulation duration of the uplink data.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting uplink data on the first CG PUSCH, uplink data on the second CG PUSCH is detected after a first duration from a first time-domain position, where the first time-domain position is the end position of the CG PUSCH resource for transmitting the uplink data. In some examples, while detecting the uplink data of the second CG PUSCH, the uplink data of the first CG PUSCH is continuously detected. In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating a configuration of at least one second CG PUSCH on a CG PUSCH in the first CG PUSCH configuration, the at least one second CG PUSCH is detected.

In some examples, the first indication information may be indication information for the configuration of the CG PUSCH, or may be indication information for the CG PUSCH in the configuration of the CG PUSCH, which is not limited in the present disclosure.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected after a second duration from a second time-domain position.

In an embodiment, the second time-domain position is determined based on a CG PUSCH resource for transmitting the first indication information. For example, the second time-domain position may be an end position of the CG PUSCH resource for transmitting the first indication information, or the second time-domain position may be a start position of the CG PUSCH resource for transmitting the first indication information. In an embodiment, the second duration may be determined by a transmission duration determined based on the CG PUSCH resource for transmitting the first indication information and a demodulation duration of the first indication information, for example, the second duration is greater than or equal to the sum of the transmission duration determined based on the CG PUSCH resource for transmitting the first indication information and the demodulation duration of the first indication information.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected after a second duration from a second time-domain position, where the second time-domain position is an end position of the CG PUSCH resource for transmitting the indication information on the first CG PUSCH.

In some examples, those skilled in the art can understand that the methods provided by the embodiments of the present disclosure can be executed alone or together with some methods in the embodiments of the present disclosure or some methods in related technologies.

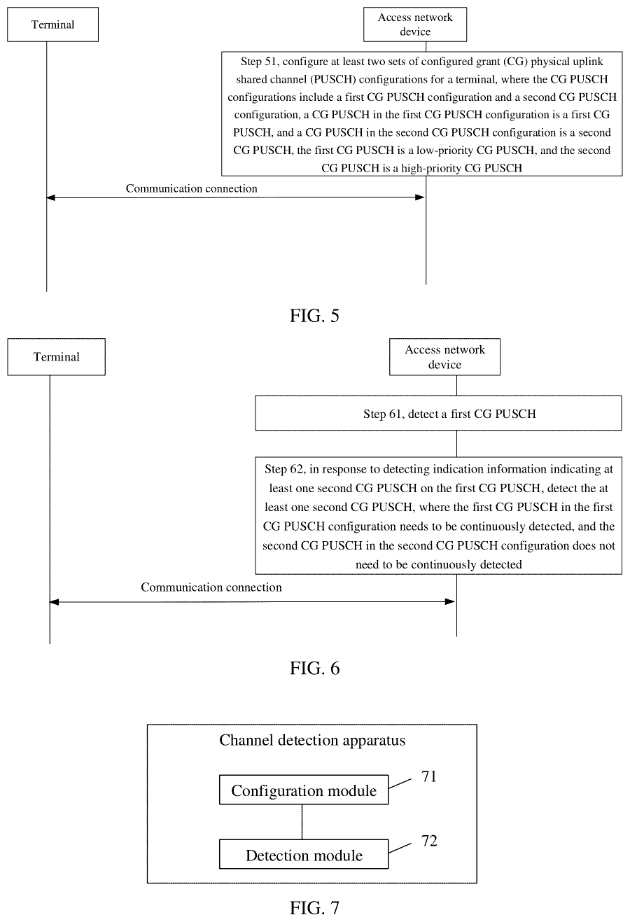

As shown in FIG. 5, a channel detection method is provided in the embodiment, which is performed by an access network device, and the method includes the following step

Step 51: configuring at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH.

The first CG PUSCH is a low-priority CG PUSCH, and the second CG PUSCH is a high-priority CG PUSCH.

In an embodiment, the first CG PUSCH in the first CG PUSCH configuration needs to be continuously detected, while the second CG PUSCH in the second CG PUSCH configuration does not need to be continuously detected.

In some examples, a high-priority CG PUSCH in the CG PUSCH configuration will be detected first.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH in the first CG PUSCH configuration is a high-priority CG PUSCH, and the second CG PUSCH in the second CG PUSCH configuration is a low-priority CG PUSCH.

In an embodiment, the access network device may configure the CG PUSCH, for example, via Radio Resource Control (RRC) signaling. The CG PUSCH configuration may include priority information. For example, the configuration of CG PUSCH includes a first CG PUSCH configuration and a second CG PUSCH configuration. The first CG PUSCH configuration may include priority information of the first CG PUSCH configuration, which is also the priority information of the first CG PUSCH in the first CG PUSCH configuration. The second CG PUSCH configuration may include priority information of the second CG PUSCH configuration, which is also the priority information of the second CG PUSCH in the second CG PUSCH configuration. The priority information indicates the priority. It may be understood that when time-frequency resources corresponding to a high-priority CG PUSCH configuration overlap with time-frequency domain resources corresponding to a low-priority CG PUSCH configuration, the time-frequency resources of the high-priority CG PUSCH configuration are detected first, or when time-frequency resources corresponding to a high-priority CG PUSCH overlap with time-frequency resources corresponding to a low-priority CG PUSCH, the time-frequency resources of the high-priority CG PUSCH are detected first.

Based on this, it may be understood that the priority corresponding to the priority information may be set for the CG PUSCH configuration or for the CG PUSCH in the CG PUSCH configuration, which is not limited in the present disclosure.

In some examples, those skilled in the art can understand that the methods provided by the embodiments of the present disclosure can be executed alone or together with some methods in the embodiments of the present disclosure or some methods in related technologies.

As shown in FIG. 6, a channel detection method is provided in the embodiment, which is performed by an access network device, and the method includes the following steps.

Step 61: detecting a first CG PUSCH.

Step 62: in response to detecting indication information indicating at least one second CG PUSCH on the first CG PUSCH, detecting the at least one second CG PUSCH, where the first CG PUSCH in the first CG PUSCH configuration needs to be continuously detected, and the second CG PUSCH in the second CG PUSCH configuration does not need to be continuously detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating a configuration of at least one second CG PUSCH on a CG PUSCH in the first CG PUSCH configuration, the at least one second CG PUSCH is detected.

In some examples, the first indication information may be indication information for the configuration of the CG PUSCH, or may be indication information for the CG PUSCH in the configuration of the CG PUSCH, which is not limited in the present disclosure.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting first indication information indicating at least one second CG PUSCH on the first CG PUSCH, the at least one second CG PUSCH is detected after a second duration from a second time-domain position, where the second time-domain position is an end position of the CG PUSCH resource for transmitting the indication information on the first CG PUSCH.

In an embodiment, at least two sets of CG PUSCH configurations are configured for the terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH. The first CG PUSCH is detected. In response to detecting CG UCI indicating at least one second CG PUSCH on the first CG PUSCH, the at least one second CG PUSCH is detected after a second duration from a second time-domain position, where the second time-domain position is an end position of the CG PUSCH resource for transmitting the CG UCI on the first CG PUSCH. The CG UCI is CG UCI carried in the CG PUSCH, and the CG UCI indicates index information of the at least one second CG PUSCH.

In some examples, those skilled in the art can understand that the methods provided by the embodiments of the present disclosure can be executed alone or together with some methods in the embodiments of the present disclosure or some methods in related technologies.

As shown in FIG. 7, an embodiment of the present disclosure provides a channel detection apparatus, including:
a configuration module 71, configured to configure at least two sets of configured grant (CG) physical uplink shared channel (PUSCH) configurations for a terminal, where the CG PUSCH configurations include a first CG PUSCH configuration and a second CG PUSCH configuration, a CG PUSCH in the first CG PUSCH configuration is a first CG PUSCH, and a CG PUSCH in the second CG PUSCH configuration is a second CG PUSCH; and
a detection module 72, configured to detect the first CG PUSCH, and detect uplink data on the second CG PUSCH when uplink data is detected on the first CG PUSCH.

In an embodiment, the detection module 72 is further configured to:
detect the uplink data on the second CG PUSCH after a first duration from a first time-domain position,
where the first time-domain position is determined based on a CG PUSCH resource for transmitting the uplink data.

In an embodiment, the detection module 72 is further configured that the first time-domain position is an end position of the CG PUSCH resource for transmitting the uplink data.

In an embodiment, the configuration module 71 is further configured that a CG PUSCH configured for the terminal includes a low-priority CG PUSCH and/or a high-priority CG PUSCH.

In an embodiment, the configuration module 71 is further configured that the high-priority CG PUSCH is configured as the first CG PUSCH.

In an embodiment, the detection module 72 is further configured to:
detect at least one second CG PUSCH when first indication information is detected on the first CG PUSCH, where the first indication information indicates the at least one second CG PUSCH.

In an embodiment, the detection module 72 is further configured to:
detect the at least one second CG PUSCH after a second duration from a second time-domain position,
where the second time-domain position is determined based on a CG PUSCH resource for transmitting the indication information.

In an embodiment, the detection module 72 is further configured that the second time-domain position is an end position of the CG PUSCH resource for transmitting the first indication information on the first CG PUSCH.

In an embodiment, the detection module 72 is further configured that the first indication information is CG uplink control information (UCI) carried in a CG PUSCH.

In an embodiment, the detection module 72 is further configured that the CG UCI indicates index information of the at least one second CG PUSCH.

In an embodiment, the detection module 72 is further configured that the first duration is specified by a predetermined communication protocol or configured by the base station, and/or the second duration is specified by a predetermined communication protocol or configured by the base station.

In some examples, those skilled in the art can understand that the methods provided by the embodiments of the present disclosure can be executed alone or together with some methods in the embodiments of the present disclosure or some methods in related technologies.

An embodiment of the present disclosure provides a communication device, including:
a processor; and
a memory, configured to store processor-executable instructions;
where the processor is configured to implement the method applied to any embodiment of the present disclosure when executing the executable instructions.

The processor may include various types of storage media that are non-transitory computer storage media capable of continuing to memorize the information stored thereon after the communication device is powered down.

The processor may be connected memory via a bus, etc., for reading an executable program stored on the memory.

An embodiment of the present disclosure further provides a computer storage medium, where the computer storage medium stores a computer executable program, and the executable program, when executed by a processor, realizes the method of any embodiment of the present disclosure.

Regarding to the apparatus in the above embodiment, a specific way in which each module performs operations has been described in detail in the embodiments relating to the method, and will not be described in detail here.

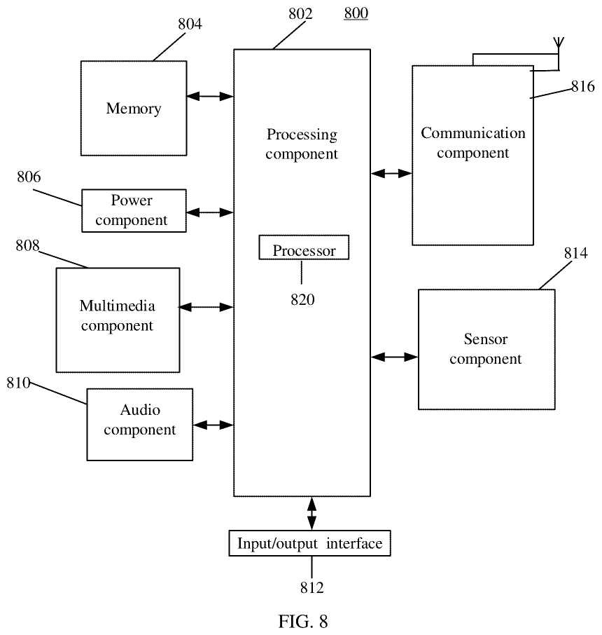

As shown in FIG. 8, an embodiment of the present disclosure provides a structure of a terminal.

Referring to FIG. 8, this embodiment provides a terminal 800, which can be a mobile phone, a computer, a digital broadcasting terminal, a messaging device, a game console, a tablet device, a medical device, a fitness device, a personal digital assistant, etc.

Referring to FIG. 8, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls an overall operation of the terminal 800, such as operations associated with display, telephone call, data communication, camera operation and recording operation. The processing component 802 may include one or more processors 820 to execute instructions to complete all or part of steps of the above-mentioned method. In addition, the processing component 802 may include one or more modules to facilitate interactions between the processing component 802 and other components. For example, the processing component 802 may include a multimedia module to facilitate interactions between the multimedia component 808 and the processing component 802.

The memory 804 is configured to store various types of data to support operations in the device 800. Examples of these data include instructions of any application program or method for being operated on the terminal 800, contact data, phone book data, messages, pictures, videos, etc. The memory 804 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing and distributing power for the terminal 800.

The multimedia component 808 includes a screen that provides an output interface between the terminal 800 and a user. In some examples, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some examples, the multimedia component 808 includes a front camera and/or a rear camera. When the device 800 is in an operation mode, such as a shooting mode or a video mode, the front camera and/or the rear camera can receive external multimedia data. Each front camera and rear camera may be a fixed optical lens system or have focal length and optical zoom capability.

The audio component 810 is configured to output and/or input audio signals. For example, the audio component 810 includes a microphone (MIC) configured to receive external audio signals when the terminal 800 is in the operation mode, such as a calling mode, a recording mode and a voice recognition mode. The received audio signal may be further stored in the memory 804 or transmitted via the communication component 816. In some examples, the audio component 810 further includes a speaker for outputting audio signals.

The I/O interface 812 provides an interface between the processing component 802 and peripheral interface modules, where the peripheral interface modules may be keyboards, click-wheels, buttons, etc. These buttons may include, but are not limited to: home button, volume button, start button and lock button.

The sensor component 814 includes one or more sensors for providing various aspects of state evaluation for the terminal 800. For example, the sensor component 814 can detect an on/off state of the terminal 800, a relative positioning of components, for example, the components are the display and the keypad of the terminal 800, and the sensor component 814 can further detect a position change of the terminal 800 or a component of the terminal 800, presence or absence of user contact with the terminal 800, orientation or acceleration/deceleration of the terminal 800 and a temperature change of the terminal 800. The sensor component 814 may include a proximity sensor configured to detect presence of a nearby object without any physical contact. The sensor component 814 may also include an optical sensor, such as a CMOS or CCD image sensor, for use in imaging applications. In some examples, the sensor component 814 may further include an acceleration sensor, a gyroscope sensor, a magnetic sensor, a pressure sensor or a temperature sensor.

The communication component 816 is configured to facilitate wired or wireless communication between the terminal 800 and other devices. The terminal 800 can access a wireless network based on communication standards, such as WiFi, 2G or 3G, or combinations thereof. In an embodiment of the present disclosure, the communication component 816 receives a broadcast signal or broadcast related information from an external broadcast management system via a broadcast channel. In an embodiment of the present disclosure, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the terminal 800 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 804 including instructions, where the instructions can be executed by a processor 820 of the terminal 800 to complete the above-mentioned delay determination method. For example, the non-transitory computer-readable storage medium may be an ROM, a random access memory (RAM), a CD-ROM, a magnetic tape, a floppy disk, an optical data storage device, etc.

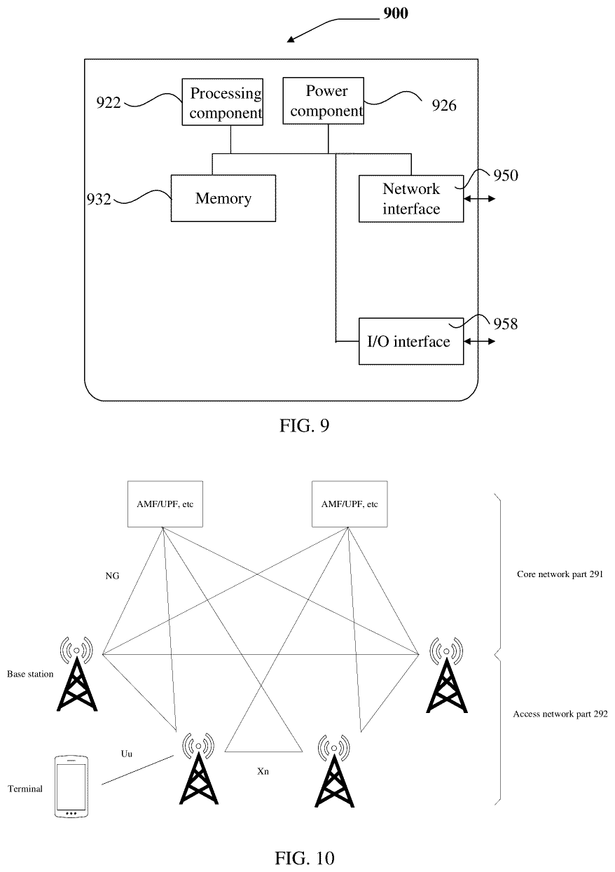

As shown in FIG. 9, an embodiment of the present disclosure shows a structure of a base station. For example, the base station 900 can be provided as a network-side device. Referring to FIG. 9, the base station 900 includes a processing component 922, which further includes one or more processors, and memory resources represented by a memory 932 for storing instructions that can be executed by the processing component 922, such as application programs. An application program stored in the memory 932 may include one or more modules each corresponding to a set of instructions. In addition, the processing component 922 is configured to execute instructions to perform any of the aforementioned methods applied to the base station.

The base station 900 may further include a power component 926 configured to perform power management of the base station 900, a wired or wireless network interface 950 configured to connect the base station 900 to a network, and an input-output (I/O) interface 958. The base station 900 can operate based on an operating system stored in the memory 932, such as Windows Server™, Mac OS X™, Unix™, Linux™, FreeBSD™ or the like.

As shown in FIG. 10, an embodiment of the present disclosure shows a network architecture of a 5G system, including a core network part 291 and an access network part 292. The core network part includes core network devices, which mainly include communication nodes such as Access and Mobility Management Function (AMF), User Plane Function (UPF), Network Exposure Function (NEF), User Data Repository (UDR), and Session Management Function (SMF). The access network includes base stations. The AMF is mainly responsible for functions related to registration management, connection management, accessibility management, mobility management, as well as security, access management, and authorization. The UPF is mainly responsible for various functions related to data plane anchor point, PDU session point connecting to data network, message routing and forwarding, traffic usage reporting and legal monitoring. The NEF is mainly responsible for providing a secure way to expose the services and capabilities of 3GPP network functions to AF and providing a secure way for AF to provide information to 3GPP network functions. The UDR is mainly responsible for storing important process data during wireless communication. The SMF is mainly responsible for various functions related to session management, billing and QoS policy control, legal monitoring, billing data collection and downlink data notification.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A channel detection method, performed by an access network device and comprising:
configuring first configured grant (CG) physical uplink shared channel (PUSCH) configuration and a second CG PUSCH configuration, wherein the first CG PUSCH configuration comprises a first CG PUSCH, and the second CG PUSCH configuration comprises a second CG PUSCH;
detecting the first CG PUSCH; and
detecting uplink data on the second CG PUSCH when uplink data is detected on the first CG PUSCH.

2. The method according to claim 1, wherein the detecting uplink data on the second CG PUSCH comprises:
detecting the uplink data on the second CG PUSCH after a first duration from a first time-domain position, wherein the first time-domain position is determined based on a CG PUSCH resource for transmitting the uplink data.

3. The method according to claim 2, wherein the first time-domain position is an end position of the CG PUSCH resource for transmitting the uplink data.

4. The method according to claim 1, wherein a CG PUSCH configured for a terminal comprises at least one of a low-priority CG PUSCH or a high-priority CG PUSCH.

5. The method according to claim 4, wherein the high-priority CG PUSCH is configured as the first CG PUSCH.

6. The method according to claim 1, wherein the detecting uplink data on the second CG PUSCH when uplink data is detected on the first CG PUSCH comprises:
detecting at least one second CG PUSCH when first indication information is detected on the first CG PUSCH, wherein the first indication information indicates the at least one second CG PUSCH.

7. The method according to claim 6, wherein the detecting at least one second CG PUSCH comprises:
detecting the at least one second CG PUSCH after a second duration from a second time-domain position, wherein the second time-domain position is determined based on a CG PUSCH resource for transmitting the first indication information.

8. The method according to claim 7, wherein the second time-domain position is an end position of the CG PUSCH resource for transmitting the first indication information on the first CG PUSCH.

9. The method according to claim 6, wherein the first indication information is CG uplink control information (UCI) carried in a CG PUSCH.

10. The method according to claim 9, wherein the CG UCI indicates index information of the at least one second CG PUSCH.

11. The method according to claim 3, wherein the first duration is specified by a predetermined communication protocol or configured by the access network device.

12.-22. (canceled)

23. A communication device, comprising:
an antenna;
a memory; and
a processor, connected to the antenna and the memory respectively, and being configured to:
configure a first configured grant (CG) physical uplink shared channel (PUSCH) configuration and a second CG PUSCH configuration, wherein the first CG PUSCH configuration comprises a first CG PUSCH, and the second CG PUSCH configuration comprises a second CG PUSCH;
detect the first CG PUSCH; and
detect uplink data on the second CG PUSCH when uplink data is detected on the first CG PUSCH.

24. A non-transitory computer storage medium, wherein the computer storage medium stores computer-executable instructions that, when executed by a processor, cause the processor to:
configure a first configured grant (CG) physical uplink shared channel (PUSCH) configuration and a second CG PUSCH configuration, wherein the first CG PUSCH configuration comprises a first CG PUSCH, and the second CG PUSCH configuration comprises a second CG PUSCH;
detect the first CG PUSCH; and
detect uplink data on the second CG PUSCH when uplink data is detected on the first CG PUSCH.

25. The method according to claim 7, wherein the second duration is specified by a predetermined communication protocol or configured by the access network device.

26. The communication device according to claim 23, wherein the processor is further configured to:
detect the uplink data on the second CG PUSCH after a first duration from a first time-domain position, wherein the first time-domain position is determined based on a CG PUSCH resource for transmitting the uplink data.

27. The communication device according to claim 26, wherein the first time-domain position is an end position of the CG PUSCH resource for transmitting the uplink data.

28. The communication device according to claim 23, wherein a CG PUSCH configured for a terminal comprises at least one of a low-priority CG PUSCH or a high-priority CG PUSCH, and the high-priority CG PUSCH is configured as the first CG PUSCH.

29. The communication device according to claim 23, wherein the processor is further configured to:
detect at least one second CG PUSCH when first indication information is detected on the first CG PUSCH, wherein the first indication information indicates the at least one second CG PUSCH.

30. The communication device according to claim 29, wherein the processor is further configured to:
detect the at least one second CG PUSCH after a second duration from a second time-domain position, wherein the second time-domain position is an end position of the CG PUSCH resource for transmitting the first indication information on the first CG PUSCH.

31. The communication device according to claim 29, wherein the first indication information is CG uplink control information (UCI) carried in a CG PUSCH, and the CG UCI indicates index information of the at least one second CG PUSCH.
